(19) United States
(12) Patent Application Publication
(10) Pub. No.: US 2006/0017317 A1
(43) Pub. Date: Jan. 26, 2006

(54) Selective actuation of secondary circuit of dual brake valve

(76) Inventors: David W. Howell, Emmaus, PA (US); Jeffrey J. Krause, Wellington, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/896,493

(22) Filed: Jul. 22, 2004

(51) Int. Cl. B60T 13/00

(52) U.S. Cl. 303/7; 303/9.62; 303/9.66; 303/127; 303/140

(57) ABSTRACT

A vehicle has a primary braking system and a secondary braking system. The vehicle has a dual brake valve with a primary circuit for pressurizing the primary system in response to application of force to a brake pedal, and a secondary circuit for pressurizing the secondary system in response to application of the primary circuit or force to a brake pedal. The vehicle also has an actuator for actuating the secondary circuit of the dual brake valve independently of the primary circuit, to provide for advanced braking functions such as roll stability and yaw stability. The actuator may be pneumatic or electric. The actuator can be energized by a vehicle electronic control unit in response to receiving a sensor output indicative of a vehicle condition.

### BACKGROUND OF THE INVENTION

1. Technical Field

This invention relates to braking systems for vehicles and, in particular, to the provision of advanced braking functions by use of a dual brake valve, or brake valve actuator, of a vehicle.

2. Description of the Prior Art

Over-the-highway vehicles typically have a primary braking system and a separate secondary braking system. A dual brake valve, or brake valve actuator, has primary and secondary circuits that control the primary and secondary braking systems, respectively, of the vehicle. When the vehicle brake pedal is depressed there is a direct mechanical movement of a piston in the primary circuit, sending primary supply air to primary delivery. Some of this air is ported to the piston of the secondary circuit, moving it to cause the sending of secondary supply air to secondary delivery. The secondary piston is not driven mechanically by the brake pedal unless there is a primary air failure and the primary piston moves far enough, under pedal pressure, that it mechanically engages the secondary piston.

Some over-the-highway vehicles with anti-lock braking system (ABS) also have an automatic traction control (ATC) function, in which braking of the driven wheels is provided without driver demand, to control wheel slippage due to engine power and low traction surfaces. This ATC function is provided typically with an ATC valve, which is an on-off valve controlled by an electronic control unit (ECU) of the vehicle braking system. When ATC is desired, the ECU opens the ATC valve, which directs air pressure to the brakes of the driven wheels through their ABS modulators. The modulators control the on-off of the supply air that is present, thus controlling the actual brake actuation.

To make a roll stability program or electronic stability program for such a vehicle, it is necessary to control also the non-driven wheels of the vehicle (for example the front axle). One needs to be able to apply selectively the brakes of the non-driven wheels, without driver interaction—including the brakes of the trailer. This function is typically accomplished by copying the ATC hardware from the primary circuit for the driven wheels, for use with the non-driven wheels in the secondary braking system. The secondary braking system is, as a result, actuated without pressing the brake pedal. The resulting system is relatively complex.

As an example, FIG. 1 shows one prior art hardware arrangement that is used for obtaining roll stability on a straight truck or bus (no trailer). The primary circuit of the dual brake valve provides driver control pressure to a relay valve (designated ATC) having an ATC solenoid, associated with the driven wheels. Supply air from the primary reservoir, as passed by the relay valve, goes to the vehicle's rear (to the right as viewed in FIG. 1) ABS wheel end modulators. The solenoid on the relay valve, and the modulators, are all under the control of the ECU, to which also is connected vehicle condition sensors (not shown in FIG. 1).

The secondary circuit of the dual brake valve provides driver control pressure to a relay valve having an ATC solenoid, associated with the non-driven (front) wheels. Supply air from the secondary reservoir, as passed by the relay valve, goes to the vehicle's front ABS wheel end modulators. The solenoid on the relay valve, and the modulators, are all under the control of the ECU. Because both the front and rear relay valves are controllable by ATC solenoids, they have reservoir air going to them, bypassing the dual brake valve, and so they can be actuated at any time with or without driver intervention, to brake the wheels.

In the prior art system shown in FIG. 1, the rear wheels (or driven wheels) are controllable in this manner for ABS and ATC, and also for stability functions. When a stability function is initiated, in response to a signal from a vehicle condition sensor, braking effect is provided at all wheels, and the ABS function is used simultaneously to prevent wheel lockup. The front wheels (or non-driven wheels) are controllable in this manner for ABS and roll stability and electronic stability functions only.

The prior art system shown in FIG. 1 also includes a pressure sensor in the secondary delivery line and a pressure sensor in the primary delivery line. These sensors sense the pressure at the delivery of the brake valve, to indicate driver demand, and deliver that indication as input to the ECU to use in controlling the event. This also indicates the potential pressure that can be delivered to the brake chambers, so that the ECU can select between driver requested pressure and stability function requested pressure. This prior art system thus requires, on top of the ABS hardware, two pressure sensors and two ATC solenoids, plus a secondary circuit relay, in order to be able to perform the stability function.

### SUMMARY OF THE INVENTION

The present invention relates to an apparatus including a dual brake valve having a primary circuit for pressurizing a primary vehicle braking system in response to application of force to a brake pedal of the vehicle, and having a secondary circuit for pressurizing a secondary vehicle braking system in response to application of the primary circuit or force to the brake pedal. The apparatus also includes an actuator for, when energized, actuating the secondary circuit independently of the primary circuit or the vehicle brake pedal.

The present invention also relates to a braking system including a dual brake valve having a primary circuit for pressurizing a primary vehicle braking system in response to application of force to a brake pedal of the vehicle, and having a secondary circuit for pressurizing a secondary vehicle braking system in response to application of the primary circuit or force to the brake pedal. The system includes one or more sensors for sensing a vehicle condition for which pressurizing of the secondary braking system is desired and for outputting a sensor output signal. The system also includes an electronic control unit electrically connected with the sensors to receive the sensor output signal. The electronic control unit is responsive to the sensor output signal to output an actuator control signal. The system further includes an actuator operatively connected with the sensor to receive the actuator control signal and to actuate the secondary circuit of the dual brake valve independently of the vehicle brake pedal.

The present invention also relates to apparatus including a dual brake valve having a primary circuit for pressurizing a primary vehicle braking system in response to application of force to a brake pedal of the vehicle, and a secondary circuit for pressurizing a secondary vehicle braking system in response to application of the primary circuit or force to the brake pedal. The apparatus also includes means for actuating the secondary circuit of the dual brake valve in response to the actuator control signal.

The present invention also relates to a method of pressurizing a secondary braking system of a vehicle that also has a primary braking system, the vehicle having a dual brake valve that includes a primary circuit for pressurizing the primary system in response to application of force to a brake pedal of the vehicle and a secondary circuit for pressurizing the secondary system in response to application of the primary circuit or force to the brake pedal. The method includes the steps of sensing a vehicle condition for which it is desired that pressurizing of the secondary braking system is desired independently of application of force to the brake pedal, and in response to the sensing, actuating the secondary circuit of the dual brake valve without actuating the primary circuit of the dual brake valve.

### BRIEF DESCRIPTION OF THE DRAWINGS

FIG. 1 is a schematic illustration of a prior art vehicle braking system;

FIG. 2 is a schematic illustration of a vehicle braking system in accordance with the present invention;

FIG. 3 is an illustration of a prior art dual brake valve;

FIG. 4 is a schematic illustration showing a first embodiment of the present invention;

FIG. 5 is a schematic illustration showing a second embodiment of the present invention;

FIG. 6 is a schematic illustration of dual brake valve showing a third embodiment of the present invention;

FIG. 7 is a schematic illustration of dual brake valve showing a fourth embodiment of the present invention; and

FIG. 8 is a schematic illustration of dual brake valve showing a fifth embodiment of the present invention.

### DETAILED DESCRIPTION OF THE INVENTION

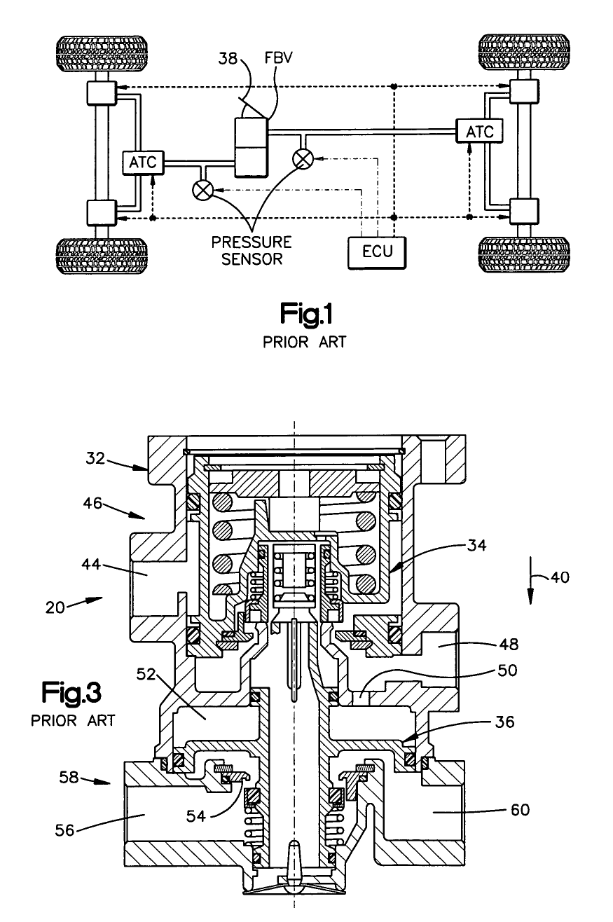

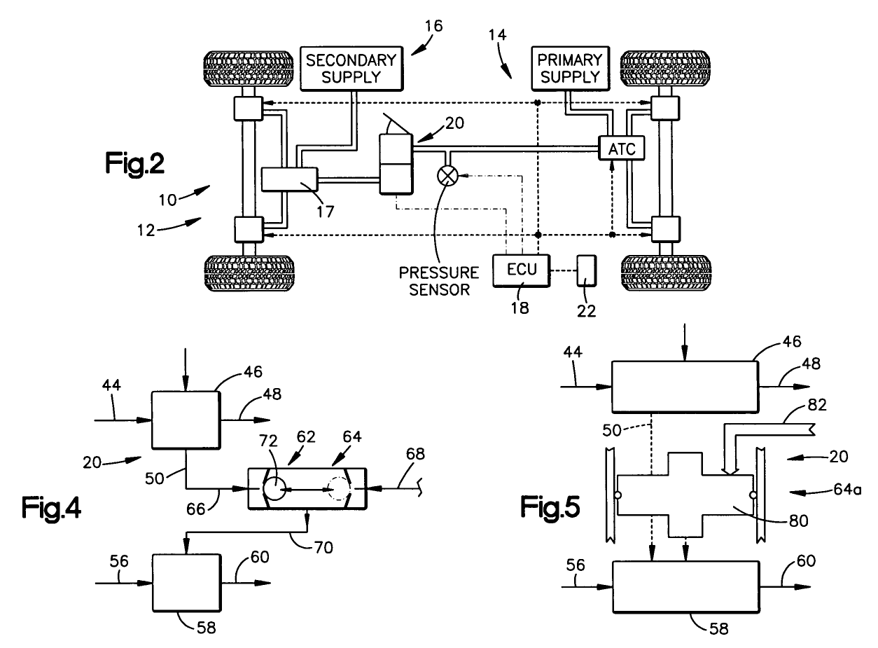

This invention relates to braking systems for vehicles and, in particular, to the provision of advanced braking functions by use of a dual brake valve, or brake valve actuator, of a vehicle. The dual brake valve might be modified or might be used unmodified. As representative of the invention, FIG. 2 shows schematically a hardware arrangement or system 10 in accordance with the present invention that is used for obtaining advanced stability on a straight truck or bus 12 (no trailer). In this regard, the system of FIG. 2 can replace the prior art system of FIG. 1.

The system 10 includes a primary braking system 13 and a secondary braking system 14. In the system 10 that is shown in FIG. 2, the ATC valve and relay for the secondary braking system 14 of the vehicle circuit is replaced with a simple quick release valve 17, or is eliminated completely.

The system 10 of FIG. 2 includes a dual brake valve, or brake valve actuator, 20. One or more vehicle condition sensors 22 is connected with an ECU 18, for sensing a vehicle condition for which pressurizing of the secondary braking system 14 of the vehicle 12 is desired, for example, to perform an advanced braking function. The sensor(s) 22 provides or sends an appropriate sensor output signal to the ECU 18. The ECU 18 receives the sensor output signal and provides or sends an appropriate actuator control signal to an actuator 64-64d (FIGS. 4-8) for actuating a secondary circuit of the dual brake valve 20.

FIG. 3 illustrates an unmodified (prior art) dual brake valve 20 having a primary circuit 46 and a secondary circuit 58. The dual brake valve 20 as shown in FIG. 3 includes a housing 32. Supported for sliding movement in the housing 32 are a first or primary piston 34, and a second or secondary piston 36. When the vehicle operator depresses the brake pedal 38, a force is applied in the direction of the arrow 40, that is, downward as viewed in FIG. 3. This force is mechanically transmitted to the primary piston 34, which moves in the housing 32 in the direction 40.

The movement of the primary piston 34 moves the primary piston off a seat, enabling air to flow from a supply port 44 of the primary circuit 46 to a delivery port 48 of the primary circuit. At the same time, a small amount of the primary circuit supply air is directed through an opening or passage 50 to a chamber 52 in which the secondary piston 36 is located. This supply air acts as a pilot pressure, moving the secondary piston 36 downward. The downward movement of the secondary piston 36 moves the secondary piston off a seat 54, enabling air to flow from a supply port 56 of the secondary circuit 58 to a delivery port 60 of the secondary circuit.

With the prior art dual brake valve 20 the secondary circuit 58 is actuated only in response to actuation of the primary circuit 46. The secondary circuit 58 is never actuated alone. The secondary piston 36 is not driven mechanically by the brake pedal 38 unless in an emergency (a primary air failure) in which case the primary piston 34 moves far enough, under pedal pressure, that it engages the secondary piston.

In a first embodiment of the invention, shown schematically in FIG. 4, the system 10 includes a shuttle valve 62 that serves as an actuator 64 for the secondary circuit 58 of the dual brake valve 20. The shuttle valve 62 has one input shown schematically at 66 that receives the pilot pressure from the primary circuit 46 of the dual brake valve 20, shown schematically at 66. The shuttle valve 62 has an auxiliary input shown schematically at 68 that receives an auxiliary pressure from a source (not shown) such as secondary supply and that is controlled by the ECU 18. The output of the shuttle valve 62 is connected to the chamber 52 of the secondary circuit 58 of the dual brake valve 20, as shown schematically at 70.

The system 10 including the ECU 18 is configured so that, during normal operation of the braking system, the pressure at the auxiliary input 68 is less than the pilot pressure at the input 66, for example, zero. In this case, a ball 72 in the shuttle valve 62 is located at the auxiliary input 68. As a result, the pilot pressure from the primary circuit 46 of the dual brake valve 20 is delivered to the output 70 of the shuttle valve 62 and acts to control actuation of the secondary circuit 58 of the dual brake valve 20.

In the event that it is desired to actuate the secondary circuit 58 of the dual brake valve 20 independently of the primary circuit 46, for example, to provide secondary circuit braking for stability purposes, the ECU 18 acts to provide an auxiliary pressure at the auxiliary input 68 of the shuttle valve 62 that is greater than the pressure at the input 66 from the primary circuit. This action in effect energizes the shuttle valve 62. Because the auxiliary pressure is greater than the input pressure delivered from the primary circuit 46 of the dual brake valve 20, the auxiliary input pressure is delivered to the output 70 of the shuttle valve 62 and thence to the chamber 52 of the secondary circuit 58 of the dual brake valve 20. As a result, the secondary piston 36 is moved to allow air to flow from the secondary supply 56 to the secondary delivery 60. The advanced braking functions can thus be effected.

The shuttle valve 62 can be incorporated in the system 10 in various different ways. For example, additional porting can be provided on the dual brake valve 20 to enable the extra output from the primary circuit 46 and the extra input to the secondary chamber 52. The shuttle valve 62 can be mounted on the side of the dual brake valve 20. Thus, the shuttle valve 62 or in fact any of the actuators of the present invention might be considered to be part of the dual brake valve 20.

In a second embodiment of the invention, shown schematically in FIG. 5, the system 10 includes an actuator 64a for the secondary circuit 58 of the dual brake valve 20. The actuator 64a includes an additional control surface, or additional piston 80, for actuating the secondary circuit 58 of the dual brake valve 20.

The additional piston or secondary piston 80, as shown schematically in FIG. 5, is interposed between the primary circuit 46 and the secondary circuit 58 of the dual brake valve 20. The secondary circuit 58 remains operable by pilot pressure from the primary circuit 46, as is indicated by the dashed line 50. The additional piston 80 is additionally energizable by an auxiliary or control pressure 82 that is received from a source (not shown) such as secondary supply and that is controlled by the ECU 18.

The ECU 18 is configured so that, during normal operation of the braking system 10, the auxiliary pressure 82 at the auxiliary piston 80 input is less than the pilot pressure 50 at the input from the primary circuit 46, for example, zero. As a result, the pilot pressure 50 from the primary circuit 46 of the dual brake valve 20 acts to control actuation of the secondary circuit 58.

In the event that it is desired to actuate the secondary circuit 58 of the dual brake valve 20 independently of the primary circuit 46, for example, to provide secondary circuit braking for stability purposes, the ECU 18 acts to provide an auxiliary pressure 82, at the auxiliary piston 80, that is greater than the pressure 50 from the primary circuit 46. This action energizes the actuator 64a. Specifically, the additional piston 80 is moved and causes the secondary piston 36 of the dual brake valve 20 to be actuated. As a result, the secondary piston 36 is moved to allow air to flow from the secondary supply 56 to the secondary delivery 60, so that advanced braking functions can be effected. The additional piston 80 can be incorporated in the vehicle braking system 10 in various different ways, for example within or attached to the housing 32 of the dual brake valve 20, within the skill of the art.

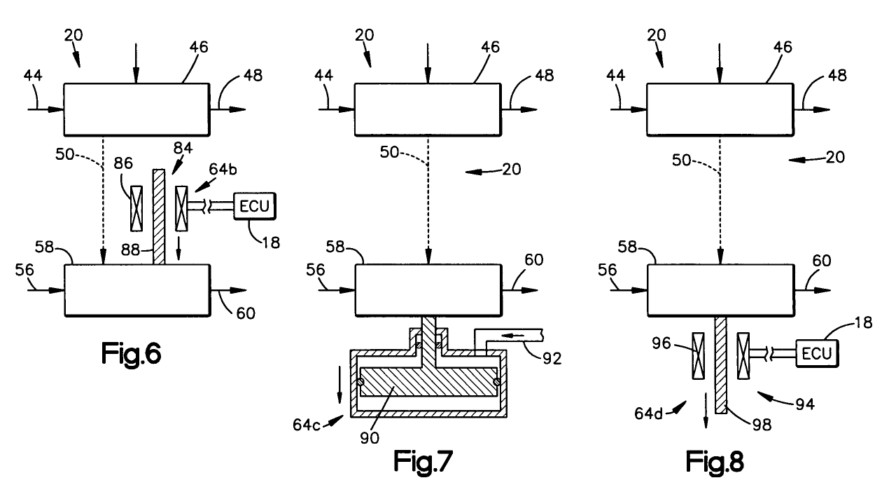

In a third embodiment of the invention, shown schematically in FIG. 6, the system 10 includes an electric actuator 64b for actuating the secondary circuit 58 of the dual brake valve 20. The electric actuator 64b, as shown schematically in FIG. 6, is associated with the secondary circuit 58 of the dual brake valve 20. The secondary circuit 58 remains operable by pilot pressure from the primary circuit 46, as is indicated by the dashed line 50.

The electric actuator 64b may be a solenoid 84 having a coil 86 and a movable member 88 that is connected with the secondary piston 36 of the dual brake valve 20. The actuator 64b can be incorporated in various ways, for example within or attached to the housing 32 of the dual brake valve 20, within the skill of the art. The actuator 64b in the embodiment of FIG. 6 is located between the primary piston 34 and the secondary piston 36 of the dual brake valve 20 so that the movable member 88 of the actuator, when energized by a current through the coil 86, pushes the secondary piston down away from the primary piston.

The electric actuator 64b is operable by a control signal from the ECU 18. The ECU 18 is configured so that, during normal operation of the braking system 10, the electric actuator 64b is not energized. As a result, the pilot pressure 50 from the primary circuit 46 of the dual brake valve 20 acts to control actuation of the secondary circuit 58, in a manner as described above.

In the event that it is desired to actuate the secondary circuit 58 of the dual brake valve 20 independently of the primary circuit 46, for example, to provide secondary circuit braking for stability purposes, the ECU 18 acts to energize the actuator 64b, for example, by sending an appropriate current through the coil 86. The actuator 64b is energized and the movable member 88 is moved, causing the secondary piston 36 of the dual brake valve 20 to be pushed down away from the primary piston 34. As a result, the secondary piston 36 is moved to allow air to flow from the secondary supply 56 to the secondary delivery 60, so that advanced braking functions can be effected.

In a fourth embodiment of the invention, shown schematically in FIG. 7, the system 10 includes an actuator 64c that includes an additional control surface, or additional piston 90, for actuating the secondary circuit 58 of the dual brake valve 20. The additional piston 90, as shown schematically in FIG. 7, is disposed below the secondary circuit 58 of the dual brake valve 20, adjacent the exhaust end of the dual brake valve, so that, when actuated, it pulls the secondary piston down 36, away from the primary piston 34. The secondary circuit 56 of the dual brake valve 20 remains operable by pilot pressure from the primary circuit 46, as is indicated by the dashed line 50. The additional piston 90 is alternatively operable through an auxiliary input 92 by an auxiliary or control pressure that is received from a source (not shown) such as the secondary supply and that is controlled by the ECU 18.

The additional piston 90 is part of an additional pneumatic actuator 64c and can be incorporated in various ways, within or attached to the housing 32 of the dual brake valve 20, within the skill of the art. The actuator 64c in the embodiment of FIG. 7 is located below the secondary circuit 56 of the dual brake valve 20, so that the additional piston 90, when actuated, pulls the secondary piston 36 away from the primary piston 34.

The ECU 18 is configured so that, during normal operation of the braking system 10, the additional pneumatic actuator 64c is not actuated. As a result, the pilot pressure 50 from the primary circuit 46 of the dual brake valve 20 acts to control actuation of the secondary circuit 58, in a manner as described above.

In the event that it is desired to actuate the secondary circuit 58 of the dual brake valve 20 independently of the primary circuit 46, for example, to provide secondary circuit braking for stability purposes, the ECU 18 acts to provide a suitable auxiliary pressure 92 to the additional piston 90. The pneumatic actuator 64c is energized and causes the secondary piston 36 of the dual brake valve 20 to be pulled away from the primary piston 34. As a result, the secondary piston 36 is moved to allow air to flow from the secondary supply 56 to the secondary delivery 60.

In a fifth embodiment of the invention, shown schematically in FIG. 8, the system 10 includes an electric actuator 64d for actuating the secondary circuit 58 of the dual brake valve 20. The electric actuator 64d, as shown schematically in FIG. 8, is associated with the secondary circuit 58 of the dual brake valve 20. The secondary circuit 58 remains operable by pilot pressure from the primary circuit, as is indicated by the dashed line 50.

The electric actuator 64d may be a solenoid 94 having a coil 96 and a movable member 98 that is connected with the secondary piston 36 of the dual brake valve 20. The actuator 64d can be incorporated in various ways, for example within or attached to the housing 32 of the dual brake valve 20, within the skill of the art. The actuator 64d in the embodiment of FIG. 8 is located below the secondary circuit 58 of the dual brake valve 20, adjacent the exhaust end of the valve 20, so that the movable member 98 of the actuator, when energized, pulls the secondary piston 36 away from the primary piston 34. The electric actuator 64d is operable by a control signal from the ECU 18.

The ECU 18 is configured so that, during normal operation of the braking system 10, the electric actuator 64d is not energized. As a result, the pilot pressure 50 from the primary circuit 46 of the dual brake valve 20 acts to control actuation of the secondary circuit 58, in a manner as described above.

In the event that it is desired to actuate the secondary circuit 58 of the dual brake valve 20 independently of the primary circuit 46, for example, to provide secondary circuit braking for stability purposes, the ECU 18 acts to energize the actuator 64d by, for example, sending an appropriate current through the coil 96. The actuator 64d is energized and causes the secondary piston 36 of the dual brake valve 20 to be pulled away from the primary piston 34. As a result, the secondary piston 36 is moved to allow air to flow from the secondary supply 56 to the secondary delivery 60.

Having described the invention, we claim:

1. Apparatus comprising:
a dual brake valve having a primary circuit for pressurizing a primary vehicle braking system in response to application of force to a brake pedal of the vehicle, and having a secondary circuit for pressurizing a secondary vehicle braking system in response to application of the primary circuit or of force to the brake pedal; and
an actuator for, when energized, actuating said secondary circuit independently of the primary circuit and the vehicle brake pedal.

2. Apparatus as set forth in claim 1 wherein said actuator is pneumatically operated.

3. Apparatus as set forth in claim 2 wherein said actuator comprises an actuator piston connected with a secondary piston of said dual brake valve for actuating said secondary circuit of said dual brake valve in response to the application of air under pressure to said actuator piston.

4. Apparatus as set forth in claim 2 wherein said actuator piston is disposed between said primary circuit of said dual brake valve and said secondary circuit of said dual brake valve.

5. Apparatus as set forth in claim 2 wherein said actuator piston is disposed adjacent an exhaust end of said dual brake valve.

6. Apparatus as set forth in claim 1 wherein said actuator is electrically operated.

7. Apparatus as set forth in claim 6 wherein said actuator comprises a solenoid that is operative to move a secondary piston of said dual brake valve to actuate said secondary circuit.

8. Apparatus as set forth in claim 1 wherein said actuator comprises a shuttle valve connected between said primary and secondary circuits of said dual brake valve.

9. Apparatus as set forth in claim 1 further including an electronic control unit and a sensor electrically connected with said electronic control unit, said electronic control unit being operable to energize said actuator in response to said sensor sensing a vehicle condition for which pressurizing of said secondary vehicle braking system is desired.

10. Apparatus as set forth in claim 9 wherein said sensor is operative to sense a vehicle condition that is indicative of vehicle stability.

11. A braking system comprising:
a dual brake valve having a primary circuit for pressurizing a primary vehicle braking system in response to application of force to a brake pedal of the vehicle, and having a secondary circuit for pressurizing a secondary vehicle braking system in response to application of the primary circuit or of force to the brake pedal;
a sensor for sensing a vehicle condition for which pressurizing of said secondary braking system is desired and for outputting a sensor output signal;
an electronic control unit electrically connected with said sensor to receive the sensor output signal, said electronic control unit being responsive to the sensor output signal to output an actuator control signal; and
an actuator operatively connected with said sensor to receive the actuator control signal and to actuate said secondary circuit of said dual brake valve independently of the primary circuit and of the vehicle brake pedal.

12. A braking system as set forth in claim 11 wherein said actuator is electrically operated and said electronic control unit is operative to energize said actuator electrically.

13. A braking system as set forth in claim 11 wherein said actuator is pneumatically operated and said electronic control unit is operative to energize said actuator pneumatically.

14. A valve as set forth in claim 11 wherein said actuator comprises a shuttle valve connected between said primary and secondary circuits of said dual brake valve.

15. Apparatus as set forth in claim 11 wherein said sensor is operative to sense a vehicle condition that is indicative of vehicle stability.

16. Apparatus comprising:
a dual brake valve having a primary circuit for pressurizing a primary vehicle braking system in response to application of force to a brake pedal of the vehicle, and a secondary circuit for pressurizing a secondary vehicle braking system in response to application of the primary circuit or of force to the brake pedal;
means for actuating said secondary circuit of said dual brake valve in response to said actuator control signal.

17. Apparatus as set forth in claim 16 further comprising means for sending said actuator control signal in response to receiving a sensor output signal.

18. Apparatus as set forth in claim 17 further comprising means for sensing a vehicle condition for which pressurizing of the secondary braking system is desirable and for providing said sensor signal.

19. A valve as set forth in claim 16 wherein said means for actuating said secondary circuit comprises a pneumatic actuator.

20. A valve as set forth in claim 16 wherein said means for actuating said secondary circuit comprises an electric actuator.

21. A valve as set forth in claim 16 wherein said means for actuating said secondary circuit comprises a shuttle valve.

22. A method of pressurizing a secondary braking system of a vehicle that also has a primary braking system, the vehicle having a dual brake valve that includes a primary circuit for pressurizing the primary system in response to application of force to a brake pedal of the vehicle and a secondary circuit for pressurizing the secondary system in response to application of the primary circuit or of force to the brake pedal, said method comprising the steps of:
sensing a vehicle condition for which it is desired that pressurizing of the secondary braking system is desired independently of application of force to the brake pedal; and
in response to said sensing, actuating the secondary circuit of the dual brake valve without actuating the primary circuit of the dual brake valve.

23. A method as set forth in claim 22 wherein said actuating step comprises directing air under pressure to a shuttle valve associated with the dual brake valve, under the control of an electronic control unit.

24. A method as set forth in claim 22 wherein said actuating step comprises directing air under pressure to a pneumatic actuator in the dual brake valve, under the control of an electronic control unit.

25. A method as set forth in claim 22 wherein said actuating step comprises electrically actuating a solenoid in the dual brake valve, under the control of an electronic control unit.

26. A method as set forth in claim 22 wherein said sensing step comprises providing a sensor output signal, said method further comprising the step of receiving the sensor output signal and in response providing an actuator control signal.

27. A method as set forth in claim 26 wherein said step of actuating the secondary circuit of the dual brake valve is performed in response to receiving the actuator control signal.
